(19) United States
(12) Patent Application Publication
(10) Pub. No.: US 2022/0362957 A1
(43) Pub. Date: Nov. 17, 2022

(54) TOOL HOLDER

(71) Applicant: Kun-Wang WANG, Tainan City (TW)

(72) Inventor: Kun-Wang WANG, Tainan City (TW)

(21) Appl. No.: 17/722,595

(22) Filed: Apr. 18, 2022

(30) Foreign Application Priority Data
May 14, 2021 (TW) 110117483

(51) Int. Cl. B26B 27/00

(52) U.S. Cl. CPC B26B 27/007

(57) ABSTRACT

A tool holder including a main body, a pressing plate and a retaining plate, wherein a long gap is formed between the pressing plate and the main body, so that a cutter can be inserted into the gap. The pawl is adjacent to the pressing plate, and two ends of the shaft rod are respectively connected with the main body, so that the pawl can rotate back and forth relative to the main body according to the shaft rod, thus preventing the pressing plate from pressing and positioning the cutter. According to the invention, the cutter setting and unloading convenience can be improved, and the positioning of the cutter setting can be changed according to the need of operation in damaging the sealant.

### CROSS-REFERENCE TO RELATED U.S. APPLICATIONS

Not applicable.

### BACKGROUND OF THE INVENTION

### 1. Field of the Invention

The present invention relates generally to a tool for placement of cutters, and more particularly to a tool holder used for removal of windshield glass.

### 2. Description of Related Art Including Information Disclosed Under 37 CFR 1.97 And 37 CFR 1.98

Different types of cutters for different applications are usually placed in a handhold. The user can conveniently grip the handhold when using the cutters.

A windshield glass is fitted on the supporting frame of a vehicle. The side of the windshield glass facing the inside of the vehicle is provided with a ring-shaped sealant made of an adhesive material. The windshield glass is mounted on the supporting frame through the sealant. The side of the windshield glass facing the outside of the vehicle is provided with a ring-shaped waterproof tape. To replace the windshield glass, the operator firstly removes the waterproof tape, and uses a cutting tool to pierce into and cut off the sealant, so that the windshield glass can be removed from the vehicle.

The cutting tool used to damage the sealant comprises a cutter holder, a cutter, a connecting rope, and a handhold, wherein one end of the cutter holder is configured with an inserting slot, one side of the cutter holder facing the inserting slot is pivoted with a steel ball and a spring, the spring forms a push against the steel ball, so that part of the steel ball can be flexibly protruded into the inserting slot. The cutter comprises an inserting portion and a cutting portion. The inserting portion has a plurality of embedding holes. When the inserting portion is inserted into the inserting slot, the steel ball can be embedded into any of the embedding holes, so that the cutter can be fixed on the cutter holder.

When the cutter is placed in the cutter holder, according to the type of the vehicle whose windshield glass needs to be removed, the depth of the inserting portion into the inserting slot is selected, and the steel ball is embedded into the corresponding embedding hole.

When the cutter is placed in the cutter holder, the steel ball blocks the inserting portion, so that, when the inserting portion is inserted into or pulled out of the inserting slot, the movement of the inserting portion is resisted, affecting the convenience of placing or removing the cutter. The spatial positions of the embedding holes form a limitation, and the cutter can only be placed at a specific position in multiple stages. This is not convenient in the operations of damaging the sealant of vehicles of different types and different specifications.

### BRIEF SUMMARY OF THE INVENTION

The main object of the invention is to provide a tool holder to improve the convenience of placing and removing the cutter, and to enable flexible positioning of the cutter to meet the need in the operation of removing the sealant.

Based on the above object, the technical feature of the invention to solve the above problems mainly lies in that, the tool holder comprises a long main body, said main body has a first end and a second end. The first end and the second end are opposite each other along the length of the main body. A virtual axial line Y is defined that goes through the first end and the second end. One side of the main body is formed with two side blocks. The side blocks are opposite each other in the lateral direction. The main body is formed with a first face that is located between the side blocks. The first face is extended on the first end.

A pressing plate is opposite the first face, and the two sides of the pressing plate are respectively opposite the side blocks, so that the side blocks respectively form a restriction to the pressing plate. A long gap is formed between the pressing plate and the first face. The gap is extended on the first end, so that a cutter can be inserted into the gap through the first end. The pressing plate has a third end and a fourth end. The third end and the fourth end are opposite each other along the direction parallel to the axial line. The third end is adjacent to the first end, and the fourth end is adjacent to the second end. The pressing plate is configured with a pin. The pin is located between the third end and the fourth end. The pin is connected to the main body along the thickness of the pressing plate, so that the pressing plate can be actuated elastically, and the third end will approach or move away from the first face, thus pressing and positioning the cutter.

A pawl is adjacent to the pressing plate, and the pressing plate is located between the pawl and the first face. The pawl is laterally pivoted with a shaft rod. The two ends of the shaft rod are respectively connected to the main body, so that the pawl can rotate back and forth relative to the main body according to the shaft rod, and the pressing plate is prevented from pressing and positioning the cutter.

The main efficacy and advantage of the invention is the improvement of convenience in placing and removing the cutter, and the flexible positioning of the cutter to meet the need in the operation of removing the sealant.

### BRIEF DESCRIPTION OF THE SEVERAL VIEWS OF THE DRAWINGS

FIG. 1 is a perspective view of Embodiment 1 of the invention.

FIG. 2 is an exploded perspective view of Embodiment 1 of the invention.

FIG. 3 is a sectional view of Embodiment 1 of the invention.

FIG. 4 is a partial enlarged view of FIG. 3.

FIG. 5 is a sectional view of the operating state of Embodiment 1 of the invention.

FIG. 6 is a sectional view of Embodiment 2 of the invention.

### DETAILED DESCRIPTION OF THE INVENTION

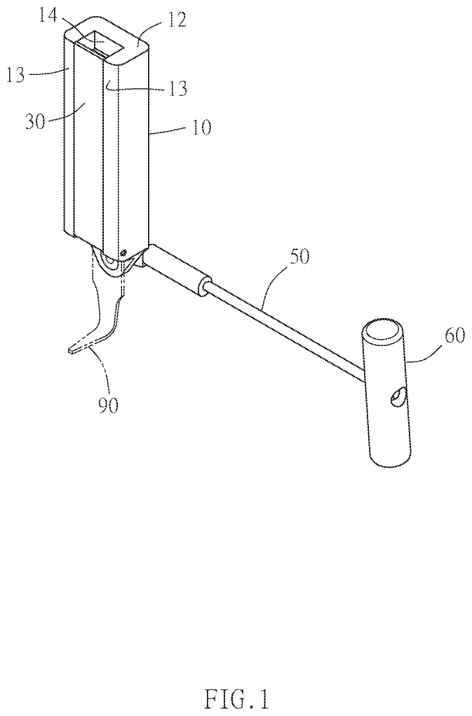

Referring to FIG. 1 through FIG. 5, Embodiment 1 of the invention of a tool holder comprises a long main body 10, a pressing plate 20 and a pawl 30, wherein the main body 10 has a first end 11 and a second end 12, the first end 11 and the second end 12 are opposite each other along the length of the main body 10. A virtual axial line Y is defined that goes through the first end 11 and the second end 12. One side of the main body 10 is formed with two side blocks 13. The side blocks 13 are opposite each other in the lateral direction. The main body 10 is formed with a first face 14. The first face 14 is located between the side blocks 13, and the first face 14 is extended on the first end 11.

The pressing plate 20 is opposite the first face 14, and the two sides of the pressing plate 20 are respectively opposite the side blocks 13, so that the side blocks 13 respectively form a restriction to the pressing plate 20. A long gap 15 is formed between the pressing plate 20 and the first face 14. The gap 15 is extended on the first end 11, so that a cutter 90 can be inserted into the gap 15 through the first end 11. The pressing plate 20 has a third end 21 and a fourth end 22. The third end 21 and the fourth end 22 are opposite each other along the direction parallel to the axial line Y, the third end 21 is adjacent to the first end 11, and the fourth end 22 is adjacent to the second end 12. The pressing plate 20 is configured with a pin 23. The pin 23 is located between the third end 21 and the fourth end 22. The pin 23 is connected to the main body 10 along the thickness of the pressing plate 20, so that the pressing plate 20 can be actuated elastically, and the third end 21 moves toward or away from the first face 14 along the arc-shaped path centered on the pin 23, thus pressing and positioning the cutter 90.

Said pawl 30 is adjacent to the pressing plate 20, and the pressing plate 20 is located between the pawl 30 and the first face 14. The pawl 30 is laterally pivoted with a shaft rod 40. The two ends of the shaft rod 40 are respectively connected to the main body 10, so that the pawl 30 can rotate back and forth relative to the main body 10 according to the shaft rod 40, and the pressing plate 20 is prevented from pressing and positioning the cutter 90.

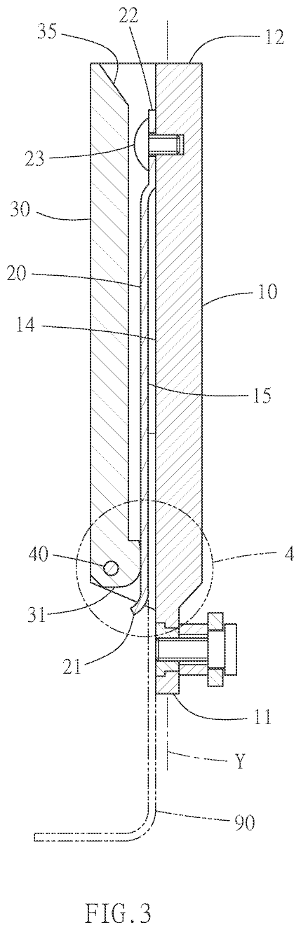

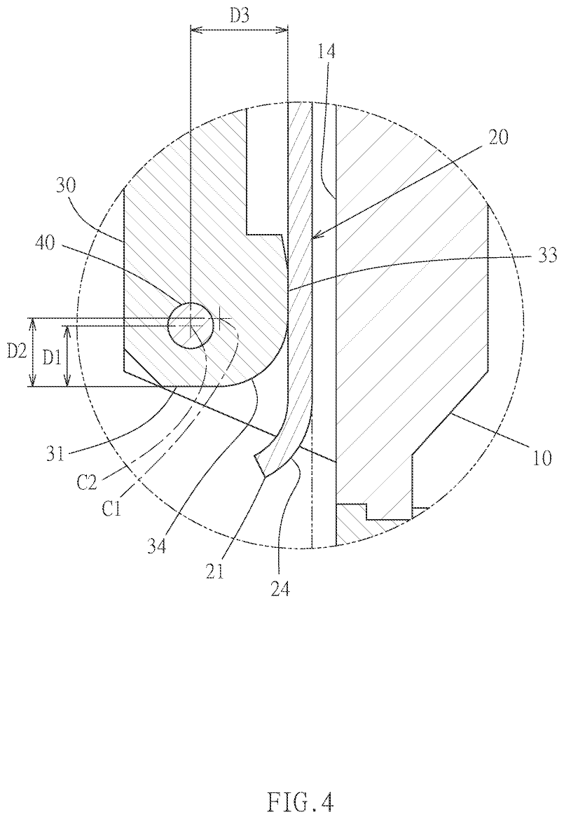

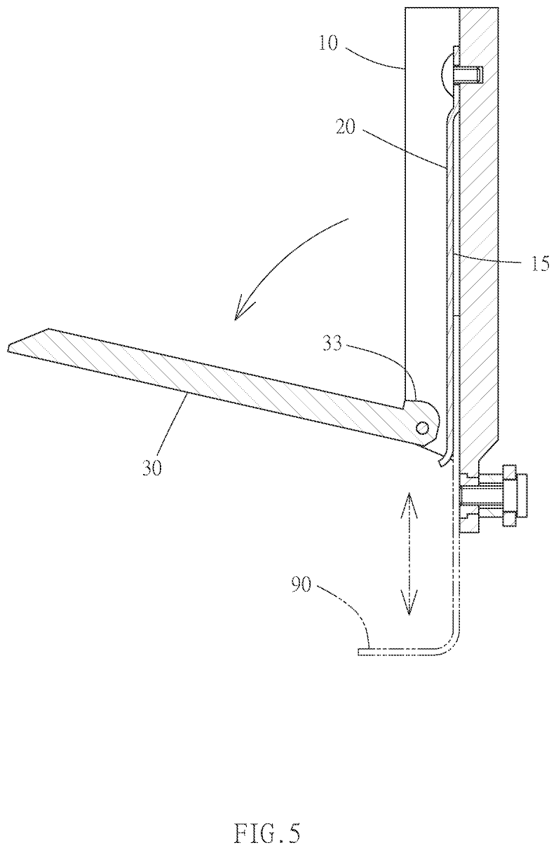

Referring to FIG. 5, when the operator pulls the pawl 30, the pawl 30 will rotate in a counter-clockwise direction marked in FIG. 5, with the shaft rod 40 as the rotation center. The elasticity of the pressing plate 20 will cause the third end 21 to move away from the first face 14 along the arc-shaped path centered on the pin 23. The cutter 90 is inserted into the gap 15 through the first end 11. When the cutter 90 enters into the gap 15 to a preset depth, the operator can pull the pawl 30 in the opposite direction, and the pawl 30 will prevent the pressing plate 20 from moving away from the pin 23. The third end 21 moves toward the first face 14 along the arc-shaped path centered on the pin 23. As shown in FIG. 3 and FIG. 4, the pressing plate 20 forms a pressure on the cutter 90. The pressing plate 20 and the first face 14 relatively clamp and position the cutter 90. Thus the cutter 90 is fixed.

The movement of the pawl 30 forms a pressure on the pressing plate 20, and through the pressure of the pressing plate 20, the cutter 90 is positioned. The rotation of the retaining plate 30 will not affect the depth of the cutter 90 into the gap 15. The user can conveniently set a proper length of the cutter 90 extending out of the gap 15, and the positioning will not be affected by the rotation of the pawl 30.

Embodiment 1 can be applied not only to a cutter 90 with a plurality of embedding holes (not shown in the figure), but also to a cutter 90 without embedding holes. By operating the pawl 30 to rotate back and forth, the cutter 90 can be easily inserted into or pulled out of the gap 15. The movement of the cutter 90 is smooth when entering or leaving the gap 15. The movement of cutter 90 will not be resisted. This enhances the convenience in placing and removing the cutter 90. On the other hand, as the pressing plate 20 is used to press the cutter 90, thereby fixing the cutter 90, the operator can select the depth of the cutter 90 inserted into the gap 15 according to the need of operation in damaging the sealant, whether the cutter 90 is configured with embedding holes or not. Therefore, the convenience is greatly enhanced.

Embodiment 1 can be applied not only to the placement of the above-mentioned cutter 90, but also to cutting tools of any type or any usage with a plate-shaped structure. Said cutting tools include cutters and scrapers.

The pawl 30 has a fifth end 31 and a sixth end 32. The fifth end 31 and the sixth end 32 are opposite each other along the direction parallel to the axial line Y. The fifth end 31 is adjacent to the third end 21, and the sixth end 32 is adjacent to the fourth end 22. The shaft rod 40 is adjacent to the fifth end 31. The side of the pawl 30 facing the pressing plate 20 is formed with a second face 33. The pawl 30 is formed with a third face 34. The third face 34 is an arc face. The two ends of the third face 34 in the direction extending along the arc are respectively adjacent to the second face 33 and the fifth end 31. The arc center C1 of the third face 34 is located between the axle center C2 of the shaft rod 40 and the second face 33, so that the pawl 30 prevents the pressing plate 20 from pressing and positioning the cutter 90.

Based on the formation of the third face 34, the distance between the axle center C2 and the fifth end 31 along the direction parallel to the axial line Y is defined as first distance D1, the distance between the arc center C2 and the fifth end 31 along the direction parallel to the axial line Y is defined as second distance D2. The first distance D1 is less than the second distance D2. When the pawl 30 rotates and the sixth end 32 approaches the fourth end 22, the second face 33 forces the third end 21 to approach the first face 14, thus pressing and positioning the cutter 90. The first distance D1 can also be equal to the second distance D2.

The distance between the axle center C2 and the second face 33 along the direction perpendicular to the axial line Y is defined as third distance D3. The first distance D1 is less than the third distance D3. When the pawl 30 rotates and the sixth end 32 approaches the fourth end 22, the second face 33 forces the third end 21 to approach the first face 14, thus pressing and positioning the cutter 90.

The pressing plate 20 is formed with a guide face 24. The guide face 24 is adjacent to the third end 21, and the guide face 24 is opposite the first face 14. The distance between the guide face 24 and the first face 14 increases gradually from the fourth end 22 to the third end 21, so as to guide the cutter 90 into the gap 15. In Embodiment 1, the guide face 24 is an arc face. Alternatively, the guide face 24 can be a slope to form another embodiment not shown in the figures.

The end of the pawl 30 away from the shaft rod 40 is formed with an operating portion 35. The operating portion 35 is opposite the first face 14, and the distance between the operating portion 35 and the first face 14 increases gradually along the axial line Y toward the tip end of the operating portion 35, so that the finger of the operator can reach into the space between the operating portion 35 and the first face 14 to press the operating portion 35, and trigger the pawl 30 to rotate.

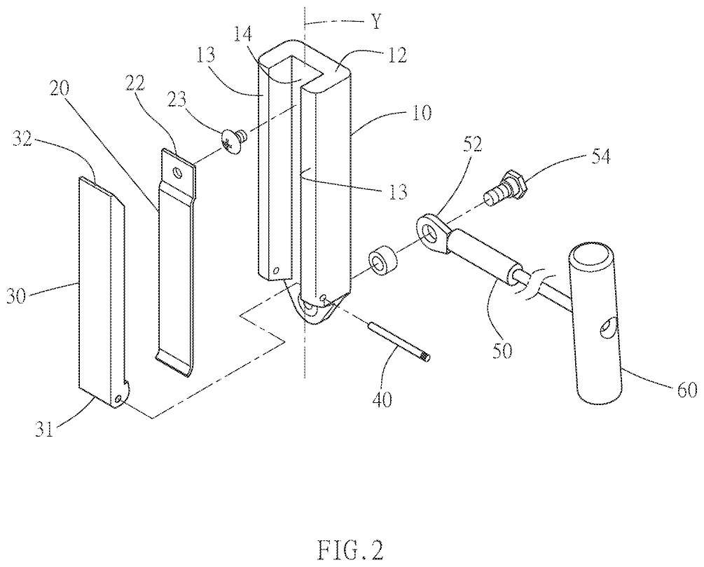

Referring to FIG. 1 and FIG. 2, Embodiment 1 further comprises a long connecting piece 50 and a handhold 60, wherein one end of the connecting piece 50 is connected to the main body 10, and the other end of the connecting piece 50 is connected to the handhold 60. By controlling the handhold 60, the connecting piece 50 can push or pull the main body 10, thus enhancing the convenience in operating the main body 10 to move. One end of the connecting piece 50 is formed with a ring portion 52. A bolt 54 goes through the ring portion 52 to be screwed onto the main body 10, so that the connecting piece 50 is connected to the main body 10, and the connecting piece 50 and the handhold 60 can rotate around the bolt 54 as needed.

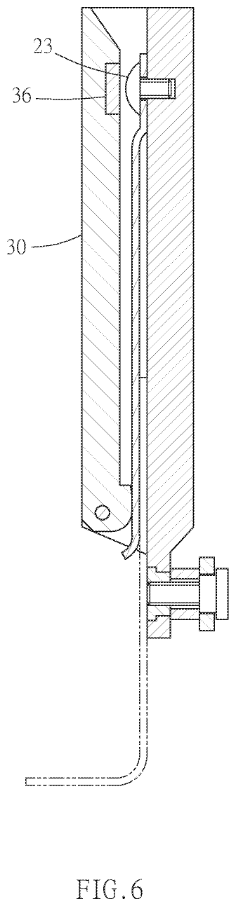

Referring to FIG. 6, Embodiment 2 differs from Embodiment 1 in that, the pawl 30 is embedded with a magnetic component 36, the pin 23 is made of a ferromagnetic material, and the magnetic component 36 is opposite the pin 23. When Embodiment 2 is not placed with the cutter 90, the magnetic absorption between the magnetic component 36 and the pin 23 can position the pawl 30.

The pressing plate 20 in Embodiment 1 can be substituted with an arc-shaped structure to form a variation not shown in the figures. The pressing plate 20 can move away from the first face 14 in the direction from the fourth end 22 to the third end 21, so that the pawl 30 can force the pressing plate 20 to press and position the cutter 90, thus enhancing the reliability of the pressing plate 20 pressing and positioning the cutter 90.

I claim:

1. A tool holder, comprising:
a long main body, said main body has a first end and a second end, the first end and the second end are opposite each other along the length of the main body, a virtual axial line Y is defined that goes through the first end and the second end, one side of the main body is formed with two side blocks, the side blocks are opposite each other in the lateral direction, the main body is formed with a first face, the first face is located between the side blocks, and the first face is extended on the first end;
a pressing plate, said pressing plate is opposite the first face, and the two sides of the pressing plate are respectively opposite the side blocks, so that the side blocks respectively form a restriction to the pressing plate, a long gap is formed between the pressing plate and the first face, the gap is extended on the first end, so that a cutter can be inserted into the gap through the first end, the pressing plate has a third end and a fourth end, the third end and the fourth end are opposite each other along the direction parallel to the axial line, the third end is adjacent to the first end, and the fourth end is adjacent to the second end, the pressing plate is configured with a pin, the pin is located between the third end and the fourth end, the pin is connected to the main body along the thickness of the pressing plate, so that the pressing plate can be actuated elastically, and the third end will approach or move away from the first face, thus pressing and positioning the cutter; and
a pawl, said pawl is adjacent to the pressing plate, and the pressing plate is located between the pawl and the first face, the pawl is laterally pivoted with a shaft rod, the two ends of the shaft rod are respectively connected to the main body, so that the pawl can rotate back and forth relative to the main body according to the shaft rod, and the pressing plate is prevented from pressing and positioning the cutter.

2. The tool holder defined in claim 1, wherein said pawl has a fifth end and a sixth end, the fifth end and the sixth end are opposite each other along the direction parallel to the axial line, the fifth end is adjacent to the third end, and the sixth end is adjacent to the fourth end, the shaft rod is adjacent to the fifth end, the side of the pawl facing the pressing plate is formed with a second face, the pawl is formed with a third face, the third face is an arc face, the two ends of the third face in the direction extending along the arc are respectively adjacent to the second face and the fifth end, the arc center of the third face is located between the axle center of the shaft rod and the second face, so that the pawl prevents the pressing plate from pressing and positioning the cutter.

3. The tool holder defined in claim 2, wherein the distance between the axle center and the fifth end along the direction parallel to the axial line is defined as first distance, the distance between the arc center and the fifth end along the direction parallel to the axial line is defined as second distance, the first distance is equal to or less than the second distance, so that the second face can press the third end to approach the first face, thus pressing and positioning the cutter.

4. The tool holder defined in claim 1, wherein said pawl has a fifth end and a sixth end, the fifth end and the sixth end are opposite each other along the direction parallel to the axial line, the fifth end is adjacent to the third end, and the sixth end is adjacent to the fourth end, the shaft rod is adjacent to the fifth end, the side of the pawl facing the pressing plate is formed with a second face, the second face is adjacent to the third end, the distance between the axle center and the fifth end along the direction parallel to the axial line is defined as first distance, the distance between the axle center and the second face along the direction perpendicular to the axial line is defined as third distance, the first distance is less than the third distance, so that the second face can press the third end to approach the first face, thus pressing and positioning the cutter.

5. The tool holder defined in claim 1, wherein said pressing plate is formed with a guide face, the guide face is adjacent to the third end, and the guide face is opposite the first face, the distance between the guide face and the first face increases gradually from the fourth end to the third end, so as to guide the cutter into the gap.

6. The tool holder defined in claim 1, wherein the end of the pawl away from the shaft rod is formed with an operating portion, so that the operator can operate the pawl to rotate.

7. The tool holder defined in claim 6, wherein said operating portion is opposite the first face, and the distance between the operating portion and the first face increases gradually along the axial line toward the tip end of the operating portion.

8. The tool holder defined in claim 1, wherein said pawl is embedded with a magnetic component, the pin is made of a ferromagnetic material, the magnetic component is opposite the pin, so as to position the pawl.

9. The tool holder defined in claim 1, which further comprises a long connecting piece and a handhold, wherein one end of the connecting piece is connected to the main body, the other end of the connecting piece is connected to the handhold, so as to enhance the convenience in operating the main body to move.

10. The tool holder defined in claim 1, wherein said pressing plate is an arc-shaped structure, and the pressing plate moves away from the first face in the direction from the fourth end to the third end, so that the pawl forces the pressing plate to press and position the cutter.
